(19) United States
(12) Patent Application Publication
(10) Pub. No.: US 2005/0149218 A1
(43) Pub. Date: Jul. 7, 2005

(54) Project manufacturing method and system

(76) Inventors: Harry Lube, Hockenheim (DE); Harald Vogel, Karlsruhe (DE)

Correspondence Address: KENYON & KENYON, 1500 K STREET, N.W., SUITE 700, WASHINGTON, DC, 20005, US

(21) Appl. No.: 10/747,242

(22) Filed: Dec. 30, 2003

(51) Int. Cl. G06F 19/00

(52) U.S. Cl. 700/100; 700/99; 700/102

(57) ABSTRACT

A project manufacturing method and system. An embodiment of a method includes receiving project order data to a production order scheduler, mapping the project order data to parameters of the scheduler, and producing a schedule from the mapped data using routines of the scheduler. As such, the method uses the existing production order routines without modification. Exemplary applications include project and product planning and assembly.

### BACKGROUND

The present invention is related to a project manufacturing system in an enterprise management software application. Enterprise management applications (EMAs) are software systems that support business organizations to manage their affairs. Thus, EMAs provide software support for example to govern purchase of materials, manufacture of goods from material components, storage of goods in warehouses and distribution of goods to partners for sale. EMAs further assist organizations to manage manufacture of goods, for example. EMAs may include a product manufacturing control system, for example, to schedule production of a particular good.

Product manufacturing systems are known. Among other things, a product manufacturing system assists organizations to schedule manufacture of their products. Manufacturing operations generally cannot be performed unless two things are available: the material components from which the product is to be made, and sufficient labor to make the product from the components. Thus, scheduling components of a product manufacturing system maintain logs that track the availability of materials and labor and, in response to production order (a request to manufacture a specified quantity of goods), reserves sufficient material and labor resources to cover the production order. The reserved resources establish a production order schedule for the quantity of goods identified in the production order request. By and large, generation of a production order schedule is an autonomous process.

Of course, many organizations do not manufacture goods as part of their business. Organizations perform consulting services, perform research and other operations that do not results in creation of tangible goods. Accordingly, there is a need in the art for an autonomous system to schedule business activities that do not create tangible assets as well as an autonomous system to schedule coordinated business and production activities.

### BRIEF DESCRIPTION OF DRAWINGS

FIG. 1 is an overview of a project manufacturing system according to an embodiment of the present invention.

FIG. 2 is a diagram of data flow according to an embodiment of the present invention.

FIG. 3 is a flowchart of an embodiment of a method according to the present invention.

FIG. 4 is an exemplary computer system for implementing an embodiment of the present invention.

### DETAILED DESCRIPTION

Embodiments of the present invention provide a project manufacturing method and system that use existing product manufacturing routines to produce a new project manufacturing schedule. As such, the project manufacturing system may extend the functionality of the existing product manufacturing system to include coordinated labor and production scheduling comprising the project schedule. To provide adequate integration between a production order scheduling system and a project order scheduling system, resources such as project personnel and project requirements are modeled in a database to correspond to the resource types on which production order systems are designed to operate (e.g., labor and materials). Effectively, the project manager ‘lies’ to the production order scheduler by presenting a request to schedule a project in a format that mimics traditional production order requests.

Thus when the project manufacturing system receives a request to manufacture a product, i.e., a production order, the existing product manufacturing routines may use production data to generate a production schedule for manufacturing the requested product. When the project manufacturing system receives a request to complete a project, i.e., a project order, the same routines may use project data to generate a project schedule for completing the requested project. By using the existing routines, embodiments of the present invention may advantageously minimize program modification needed to generate the project schedule. And the project manufacturing system may schedule both production and project orders.

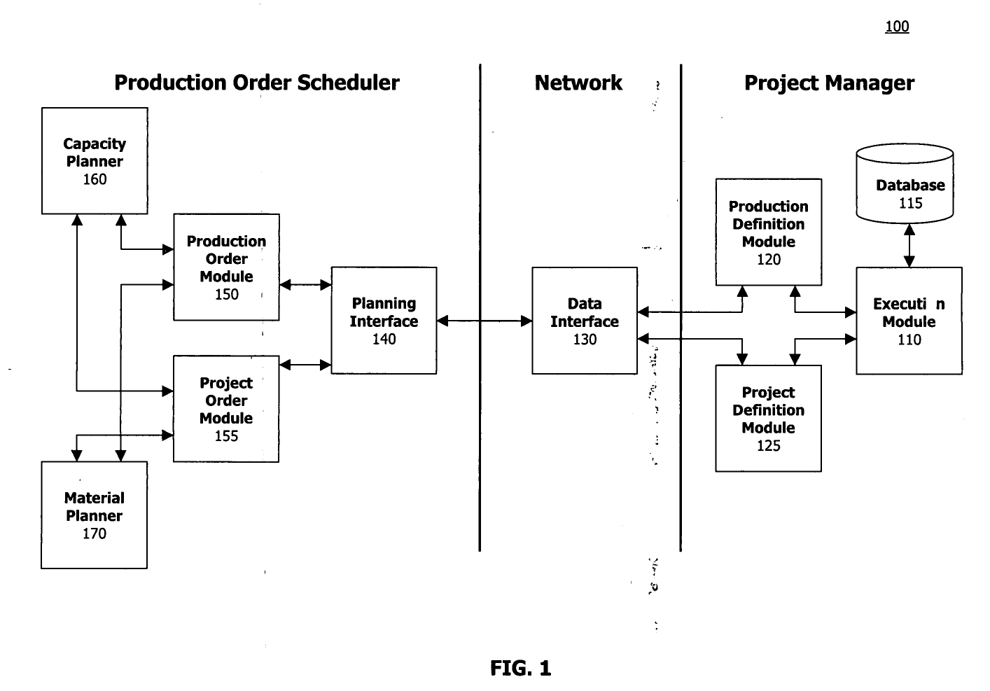

FIG. 1 is an overview of an embodiment of the project manufacturing system. The project manufacturing system 100 may include a project manager, a network, and a production order scheduler. The production order scheduler may include a planning interface 140, a production order module 150, a capacity planner unit 160, and a material planner unit 170. The planning interface 140 may receive filtered production data from the data interface 130 and transmit it to the production order module 150 for storage. The planning interface 140 may, in turn, filter the production schedule prior to transmission and transmit only the portion of the schedule relevant to the production order. The production order module 150 may store the production data and the generated schedule on the production order scheduler. The schedule may include start and end dates for each production activity and start and end dates for acquiring and/or producing materials to be used in the requested product.

The capacity planner 160 may generate the activity start and end dates using the production activities and capacity constraints from the production order module 150. Similarly, the material planner 170 may generate the material acquisition and/or production start and end dates using the activity start and end dates from the capacity planner 160 and product constraints from the production order module 150. In this regard, the structure and operation of a production order scheduler is well known.

Embodiments of the present invention integrate the production order scheduler with the project manager to extend operation of the production order scheduler to new dimensions. Thus, a network provides a data interface 130 between the project manager and the production order scheduler.

The project manager may maintain all the production data, including the production schedule, and report the schedule to the appropriate person and/or machine to carry out the schedule. The project manager may maintain the production data in a production definition module 120. Similarly, the project manager may maintain all the project data, including the project schedule, and report the schedule to the appropriate person and/or machine to carry out the schedule. The project manager may maintain the project data in a project definition module 125. The project manager may also include an execution module 110 to make updates to the schedules and perform the reporting out. The execution module 110 may access a database 115 that includes any additional data useful in generating the project and production schedules.

Exemplary project data may include the project schedule, the activities to be performed to complete the scheduled project, the sequence of the activities, the materials required to complete the project activities (“the material requirements”), the time needed to complete the activities (“the capacity requirements”), and any other data needed to schedule the project. The material requirements may include people, machines, components, raw materials, and the like.

The network data interface 130 may transmit the project (or production) data and the schedule between the project manager and the production order scheduler. The data interface 130 may also filter the project (or production) data prior to sending it to the scheduler based on whether the data is for production or project manufacturing. Header information may therefore include a unique identifier for each respective order type and particular order within that type. Upon reading the identifier, the data interface 130 may then selectively send the data associated with the identified order type. Additionally, the data interface 130 may filter the data based on the particular project (or product) and send only the portion of the data relevant to the project (or product). The data filtering advantageously reduces the data transmission load on the network and data computation load on the scheduler, resulting in faster and more efficient program performance. The network may be a LAN, WAN, or any like transmission media.

The production order scheduler may be extended to include a project order module 155 to store the project data and the generated project schedule on the production order scheduler. The schedule may include start and end dates for each project activity and start and end dates for acquiring and/or producing materials to be used in the project. The project order module 155 may also map the project data into the parameters ordinarily used by the production order scheduler to generate production schedules.

In embodiments of the present invention, the planning interface 140 may be extended to, upon receipt of filtered data from the data interface 130, read the unique identifier and select either the production order module 150 or the project order module 155 based on the identifier. Upon selection, the planning interface 140 may transmit the filtered data to the appropriate module for storage. The planning interface 140 may also filter the project (or production) schedule prior to sending it to the data interface 130 and transmit only the portion of the schedule relevant to the order type.

In addition to generating production activity dates, the capacity planner 160 may generate the project activity start and end dates using the production order routines operating on the mapped activities, activity sequence, and capacity requirements from the project order module 155. The capacity planner 160 may advantageously provide constrained capacity functionality that automatically prevents overcapacity scheduling, thereby saving the user from having to make manual adjustments when the generated schedule produces a conflict. Similarly, the material planner 170 may generate the project material acquisition and/or production start and end dates using the production order routines operating on the project activity start and end dates from the capacity planner 160 and the mapped material requirements from the project order module 155.

In this embodiment, the project manager may connect to the network through the project definition module 125 and the production definition module 120 and the scheduler may connect to the network through the planning interface 140. It is to be understood that the connection configurations are not limited to those described herein.

In an alternate embodiment, the material planner 170 may generate new material requirements, if needed, to include any new materials that are required based on the generated schedule. For example, if the originally specified materials are not available or would take too long to acquire or produce, the material planner 170 may generate a list of alternative materials to replace the originally specified materials. The material planner 170 may then calculate the acquisition and/or production start and end dates for the new materials. The new material requirements and the new material dates may be stored on the project order module 155 and then transmitted to the project definition module 125 for storage.

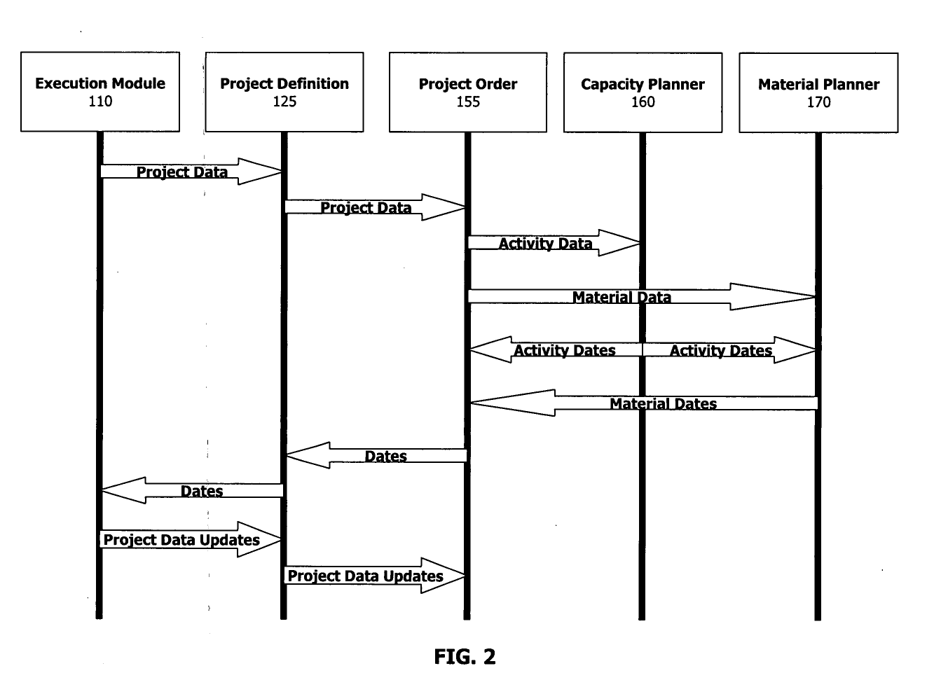

FIG. 2 is a diagram of data flow between the components of an embodiment of the project manufacturing system when generating a project schedule. First, a user or processor may input the project data via the execution module 110. The execution module 110 may then store the data in the project definition module 125. The data interface 130 may send the project data from the project definition module 125 to the project order module 155. For simplicity, the data interface 130 and the planning interface 140 are not shown, with the understanding that the data is properly filtered by the interfaces prior to sending the data to the desired modules.

Upon receipt of the project data, the project order module 155 may map the data to the appropriate production order parameters and store the data. The capacity planner 160 may then read the activity data, including the activities, the activity sequence, and the capacity requirements, from the project data in the project order module 155. The material planner 170 may read the material data, including the material requirements, from the project data in the project order module 155.

The capacity planner 160 may generate the activity dates and transmit the dates to the project order module 155 for storage and to the material planner 170 for use in generating the material dates. The material planner 170 may calculate the material dates and transmit the dates to the project order module 155 for storage.

The planning interface 140 may send the activity and material dates from the project order module 155 to the project definition module 125 for storage. The execution module 110 may read the dates from the project definition module 125 and then report the dates out to the appropriate user and/or machine to carry out the schedule.

As the scheduled activities and material tasks proceed, the user and/or processor may input the status to the execution module 110. The execution module 110 may then update the project data, including generate new activity and/or material requirements, if needed, based on the current status. The execution module 110 may then transmit the updates to the project definition module 125 for storage. The data interface 130 may then transfer the updates to the project order module 155. If needed, the capacity planner 160 and the material planner 170 may generate new dates. Hence, the data flow repeats.

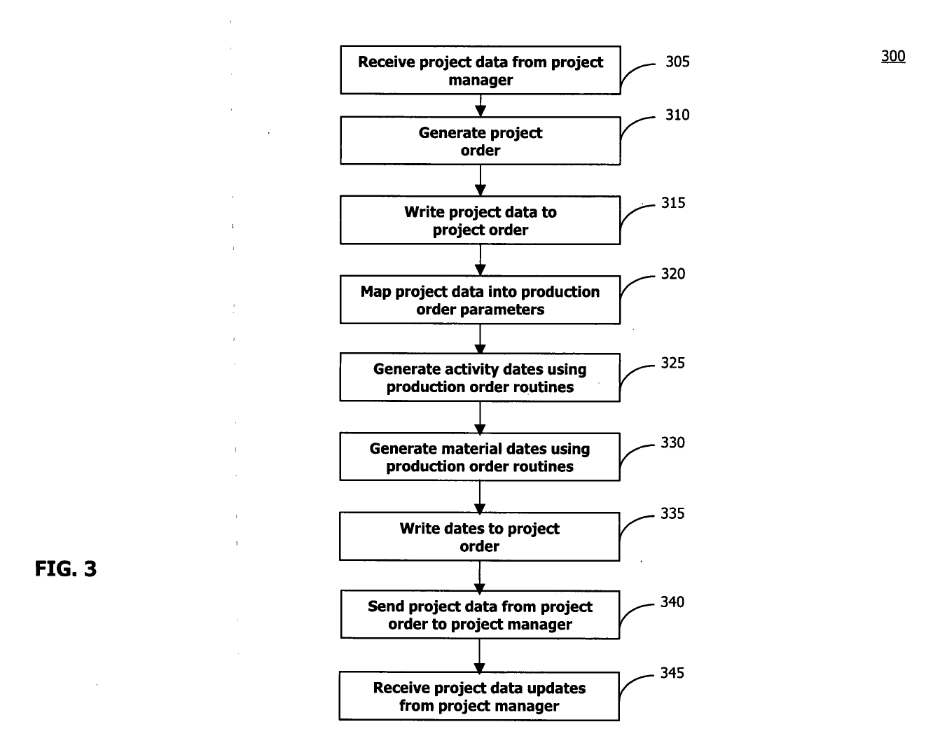

FIG. 3 is a flowchart of an embodiment of a method according to the present invention. First, the production order scheduler may receive (305) project data from the project manager. The project data may include data inputted to the execution module 110 of the project manager by a user and/or processor and data generated, i.e., capacity and material requirements, by the execution module 110 based on the inputted data. The execution module 110 may generate the project definition module 125 and store the project data therein. The project data may also include a header identifying the type of order the data represents.

The data interface 130 may read the project data from the project definition module 125 and parse the header to identify the type of order. Based on this identification, the data interface 130 may filter the data and send the relevant data to the scheduler.

Upon receipt of the data, the scheduler may generate (310) the project order module 155 and the planning interface 140 may write (315) the filtered data to the project order module 155. The project order module 155 may map (320) the project data to the production order parameters. The capacity planner 160 may generate (325) the activity dates using the production order routines. The material planner 170 may generate (330) the material dates using the production order routines. The planners may then write (335) the dates to the project order module 155.

The planning interface 140 may send (340) the dates (and any project data) from the project order module 155 to the project manager. The planning interface 140 may, prior to sending, filter the dates and send only the dates that are relevant to the type of order.

When there is a status change or completion, the user and/or processor may input the new status to the system. The execution module 110 may store the updates in the project definition module 125. The scheduler may then receive (345) the updates and generate a new schedule, if needed, based on the updates.

For example, suppose a project to build a computer is to be scheduled. Using embodiments of the present invention, a user and/or processor inputs a list of activities needed to build the computer, e.g., designing the computer, generating a parts list, building the parts, assembling the parts, and testing the built computer. The user and/or processor also input the sequence in which the activities are to be performed, and the people, equipment, and materials needed.

Upon receipt of this input, the system calculates the time required to perform each activity based on time formulas stored in the system. The time formulas are functions of the number of people and equipment to be used, the expected performance speed, and any other time factors. In addition, the system calculates the materials required to perform each activity based on material formulas stored in the system. The material formulas are functions of the specifications stored in the system for manufacturing particular products.

The system calculates the start and end dates for performing each activity and acquiring or producing the materials to build the computer. The system then reports the schedule to the user and/or machine to perform the project.

Embodiments of the present invention may be implemented using any type of computer, such as a general-purpose microprocessor, programmed according to the teachings of the embodiments. The embodiments of the present invention thus also includes a machine readable medium, which may include instructions, which may be used to program a processor to perform a method according to the embodiments of the present invention. This medium may include, but is not limited to, any type of disk including floppy disk, optical disk, and CD-ROMs.

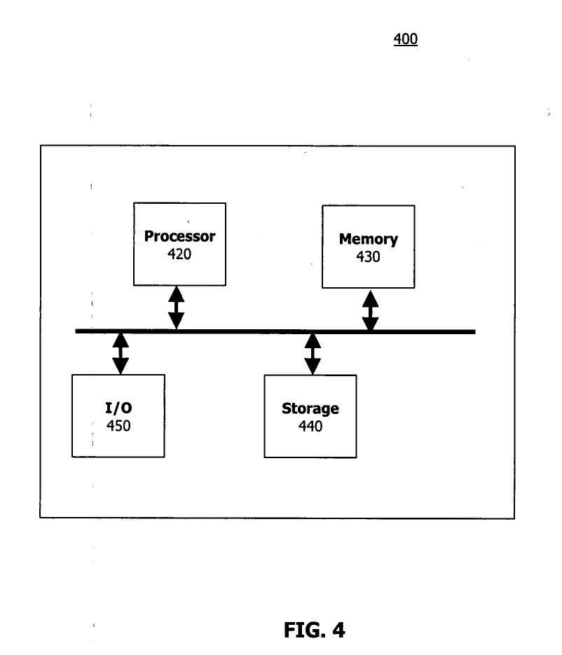

FIG. 4 is a block diagram of one embodiment of a computer system that can implement embodiments of the present invention. The system 400 may include, but is not limited to, a processor 420 provided in communication with a system memory module 430, a storage device 440, and an I/O device 450. Conventionally, the memory 430 may store program instructions to be executed by the processor 420 and also may store variable data generated pursuant to program execution. In practice, the memory 430 may be a memory system including one or more electrical, magnetic, or optical memory devices.

It may be understood that the structure of the software used to implement the embodiments of the invention may take any desired form, such as a single or multiple programs. It may be further understood that the method of an embodiment of the present invention may be implemented by software, hardware, or a combination thereof.

The above is a detailed discussion of the preferred embodiments of the invention. The full scope of the invention to which applicants are entitled is defined by the claims hereinafter. It is intended that the scope of the claims may cover other embodiments than those described above and their equivalents.

1. A method comprising:
receiving project order data at a production order scheduler;
mapping the project order data to production order parameters of the scheduler; and
producing a project order schedule from the mapped data using routines of the scheduler.

2. The method of claim 1, wherein the receiving includes:
receiving a header to identify the type of order the data represents attached to capacity requirements and material requirements of a project.

3. The method of claim 2, wherein the requirements are generated based on at least one of activities to be performed, performance sequence of the activities, people to perform the activities, and equipment to perform the activities.

4. The method of claim 1, wherein the mapping includes:
mapping activities to be performed, performance sequence of the activities, and capacity requirements to production order activity parameters, production order sequence parameters, and production order capacity parameters, respectively; and
mapping activity dates and material requirements to production order date parameters and production order material parameters, respectively.

5. The method of claim 1, wherein the producing includes:
generating start and end dates of activities to be performed; and
generating start and end dates for acquiring or producing materials to be used.

6. The method of claim 1, further comprising:
prior to the receiving, filtering the project order data to include the portion of the data that is relevant to the type of order.

7. The method of claim 1, further comprising:
sending the project order schedule to a user or a machine to be performed.

8. The method of claim 1, further comprising:
receiving data updates to the scheduler; and
performing the mapping and producing with the data updates.

9. The method of claim 1, further comprising:
after completion of the schedule, deleting the schedule.

10. A method comprising:
receiving scheduling data;
selecting a type of schedule to be generated from the data;
mapping the data to scheduler parameters based on the selection; and
producing the type of schedule from the mapped data using routines of the scheduler.

11. The method of claim 10, wherein the type of schedule includes a project schedule and a production schedule.

12. The method of claim 10, wherein the selecting includes:
identifying the type of schedule based on an identifier attached to the data.

13. A project manufacturing scheduling system comprising:
a project manager to maintain a project order schedule;
a production order scheduler to map project data into parameters of the scheduler and generate the schedule using routines of the scheduler; and
a data interface in communication with the manager and the scheduler to transmit the schedule therebetween.

14. The system of claim 13, wherein the project manager includes:
an execution module to update the schedule and report the schedule; and
a project definition module to store the project data.

15. The system of claim 13, wherein the production order scheduler includes:
a project order module to store the schedule;
a capacity planner to generate start and end dates of project activities for the schedule;
a material planner to generate start and end dates of acquiring or producing project materials for the schedule; and
a planning interface to transmit the schedule from the project order module to the project manager.

16. A machine readable medium containing program instructions for execution on a processor, which when executed by the processor, cause the processor to perform:
receiving scheduling data in response to a request;
selecting a type of schedule to generate based on the request;
mapping the data to scheduler parameters based on the selection; and
producing the type of schedule from the mapped data using scheduler routines.

17. The machine readable medium of claim 16, further comprising:
prior to the mapping, filtering the data to select a portion of the data to be mapped based on the request; and
mapping the portion of the data.

18. The machine readable medium of claim 16, further comprising:
if the type of schedule is a production schedule, excluding the mapping of the data; and
if the type of schedule is a project schedule, including the mapping of the data.
